(19) United States
(12) Patent Application Publication
(10) Pub. No.: US 2022/0076185 A1
(43) Pub. Date: Mar. 10, 2022

(54) PROVIDING IMPROVEMENT RECOMMENDATIONS FOR PREPARING A PRODUCT

(71) Applicant: PH Digital Ventures UK Limited, St. Albans (GB)

(72) Inventors: David Pierre de Prez, Prosper, TX (US); Sara Awadallah, Dallas, TX (US)

(21) Appl. No.: 17/015,952

(22) Filed: Sep. 9, 2020

(51) Int. Cl. G06Q 10/06; G06Q 50/04; G06N 20/00; G06N 5/04

(52) U.S. Cl. CPC G06Q 10/06395; G06Q 10/06393; G06N 5/04; G06N 20/00; G06Q 50/04

(57) ABSTRACT

A method for providing improvement recommendations to a first group of a plurality of groups for preparing a product. The method comprising receiving data including: preparation data associated with tasks for preparing the product for each of the plurality of groups, result data associated with results for preparation of the product for each of the plurality of groups, and standards data associated with standards for the results for preparation and tasks for preparing the product. The method further comprising analyzing, for the first group, the preparation data and the result data relative to the corresponding standards data; identifying a first result that is deficient relative to the standards; determining one or more of the tasks associated with the first result that are deficient relative to the standards; and sending, to an electronic device of the first group, at least one improvement recommendation for improving the first result.

### TECHNICAL FIELD

Embodiments of the present disclosure relate to a method of providing improvement recommendations for preparing a product. The method can be used in retail and manufacturing applications and specifically in applications for preparing food.

### BACKGROUND

In retail and manufacturing applications, business owners are provided with a number of standards and guidelines to which a product prepared by the owner should conform. Additionally, business owners are provided customer feedback related to the customer's satisfaction or dissatisfaction with the business owner's product.

Although business owners are provided with an abundance of standards and feedback regarding their product, it is often not clear what steps a business owner can take to improve their product to meet the standards and the feedback. Business owners are often left overwhelmed by the amount of feedback they receive on their product and are unsure how to implement the feedback into actionable steps to improve the product.

Specifically, in the area of food preparation, business owners take into account a number of considerations when preparing their food product, such as food taste, food temperature, food presentation, restaurant cleanliness, wait staff attentiveness, and many others. A restaurant owner may have to comply with certain standards or may receive customer feedback regarding any one of these considerations. However, it may not be clear to the restaurant owner how to implement actions to improve their product to conform with the standards or customer expectations.

### BRIEF DESCRIPTION OF THE DRAWINGS

FIG. 1 illustrates an example network system in which various embodiments of the present disclosure may be implemented;

FIG. 2 illustrates an example server in a networked system according to various embodiments of the present disclosure;

FIG. 3 illustrates an example electronic device in a networked system according to various embodiments of the present disclosure;

FIG. 4 illustrates a flowchart of a method of providing improvement for the preparation of a product by a group according to various embodiments of the present disclosure;

FIG. 5 illustrates a flowchart of a method for providing improvement recommendations using machine learning performable by a server according to various embodiments of the present disclosure;

FIG. 6 illustrates an example of an opportunities screen of an electronic device according to various embodiments of the present disclosure;

FIG. 7 illustrates an example of an improvement recommendation details screen of an electronic device according to various embodiments of the present disclosure;

FIG. 8 illustrates an example of a score review screen of an electronic device according to various embodiments of the present disclosure; and

FIG. 9 illustrates an example of a leader board screen of an electronic device according to various embodiments of the present disclosure.

### SUMMARY

Embodiments of the present disclosure provide improvement recommendations for preparing a product.

In one embodiment, a method for providing improvement recommendations for preparing a product is provided. The method comprises receiving data related to the product from data sources, the data including: preparation data associated with tasks for preparing the product for each of a plurality of groups creating the product, the plurality of groups being within an enterprise, result data associated with results for preparation of the product for each of the plurality of groups, and standards data associated with standards for the enterprise for the results for preparation of the product and for the tasks for preparing the product. The method further comprises analyzing, for a first of the plurality of groups, the preparation data associated with the tasks and the result data associated with the results for preparation of the product relative to the standards data for the results for preparation of the product and for the tasks for preparing the product in the standards data. The method further comprises identifying, based on results of the analyzing, a first of the results of the first group that is deficient relative to the standards for the first result in the standards data. The method further comprises determining one or more of the tasks that are associated with the first result and that are deficient relative to the standards for the one or more tasks for preparing the product in the standards data and sending, to an electronic device associated with the first group, at least one improvement recommendation including information about performing the one or more tasks and the standards for the one or more tasks.

In another embodiment, server for providing improvement recommendations for preparing a product is provided. The server is configured to receive data related to the product from data sources, the data including: preparation data associated with tasks for preparing the product for each of a plurality of groups creating the product, the plurality of groups being within an enterprise, result data associated with results for preparation of the product for each of the plurality of groups, and standards data associated with standards for the enterprise for the results for preparation of the product and for the tasks for preparing the product. The server is further configured to analyze, for a first of the plurality of groups, the preparation data associated with the tasks and the result data associated with the results for preparation of the product relative to the standards data for the results for preparation of the product and for the tasks for preparing the product in the standards data. The server is further configured to identify, based on results of the analyzing, a first of the results of the first group that is deficient relative to the standards for the first result in the standards data. The server is further configured to determine one or more of the tasks that are associated with the first result and that are deficient relative to the standards for the one or more tasks for preparing the product in the standards data and send, to an electronic device associated with the first group, at least one improvement recommendation including information about performing the one or more tasks and the standards for the one or more tasks.

In yet another embodiment, a non-transitory, computer-readable medium is provided. The computer-readable medium comprises program code that, when executed by a server, causes the server to: receive data related to the product from data sources, the data including: preparation data associated with tasks for preparing the product for each of a plurality of groups creating the product, the plurality of groups being within an enterprise, result data associated with results for preparation of the product for each of the plurality of groups, and standards data associated with standards for the enterprise for the results for preparation of the product and for the tasks for preparing the product. The computer-readable medium further comprises program code that, when executed by the server, causes the server to analyze, for a first of the plurality of groups, the preparation data associated with the tasks and the result data associated with the results for preparation of the product relative to the standards data for the results for preparation of the product and for the tasks for preparing the product in the standards data. The computer- readable medium further comprises program code that, when executed by the server, causes the server to identify, based on results of the analyzing, a first of the results of the first group that is deficient relative to the standards for the first result in the standards data. The computer-readable medium further comprises program code that, when executed by the server, causes the server to determine one or more of the tasks that are associated with the first result and that are deficient relative to the standards for the one or more tasks for preparing the product in the standards data and send, to an electronic device associated with the first group, at least one improvement recommendation including information about performing the one or more tasks and the standards for the one or more tasks.

### DETAILED DESCRIPTION

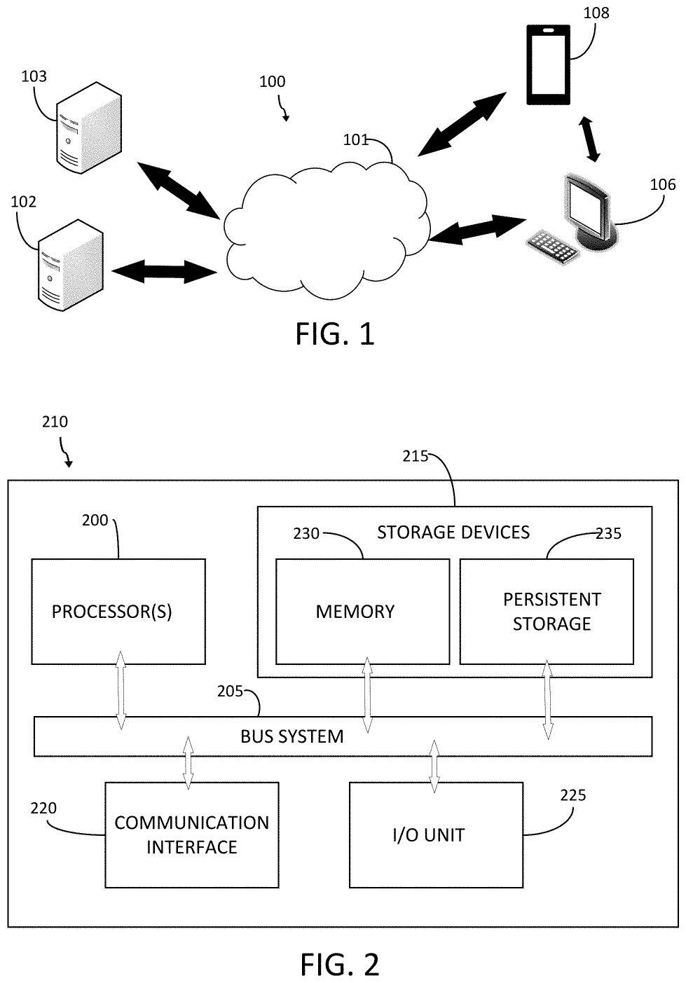

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 illustrates an example networked system 100 in which various embodiments of the present disclosure may be implemented. The embodiment of the networked system 100 shown in FIG. 1 is for illustration only. Other embodiments of the networked system 100 could be used without departing from the scope of this disclosure.

As shown in FIG. 1, the system 100 includes a network 101, which facilitates communication between various components in the system 100. For example, the network 101 may communicate Internet Protocol (IP) packets or other information between network addresses. The network 101 may include one or more local area networks (LANs); metropolitan area networks (MANs); wide area networks (WANs); a virtual private network (VPN); all or a portion of a global network, such as the Internet; or any other communication system or systems at one or more locations.

The network 101 facilitates communications among various servers 102-103 and various electronic devices 106-108 that can be associated with different group of a plurality of group. Each of the electronic devices 106-108 can be referred to as group electronic devices. Each of the servers 102-103 may be any suitable electronic computing or processing device(s) that can provide computing services including software and cloud computing for one or more group electronic devices 106-108. Each of the servers 102-103 could, for example, include one or more processing devices, one or more memories storing instructions and data, and one or more network interfaces facilitating communication over the network 101. For example, server 102 may be a data server used to store, processes, analyze, and secure data to generate and provide improvement recommendations, as will be further discussed in greater detail below. Server 103 may be an application server to provide for web applications, desktop applications, client applications, and/or mobile applications for presenting improvement recommendations. The servers 102-103 may be physical servers hosted by an entity or virtual servers as part of a cloud computing environment.

Each group electronic device 106-108 represents any suitable electronic computing or processing device that interacts with at least one server or other computing device(s) over the network 101. In this example, the group electronic devices 106-108 include a desktop computer 106 and a mobile telephone or smartphone 108; other client devices can include a tablet computer, a laptop computer, etc. Any other or additional client devices could be used in the networked system 100. The group electronic devices 106-108 may be used to present the improvement recommendations generated by the server 102 to the group associated with the group electronic device 106-108, as further discussed in greater detail below.

Although FIG. 1 illustrates one example of a networked system 100, various changes may be made to FIG. 1. For example, the system 100 could include any number of each component in any suitable arrangement and each of servers 102-103 and group electronic devices 106-108 may be representative of any number of servers and/or group electronic devices that are part of system 100. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

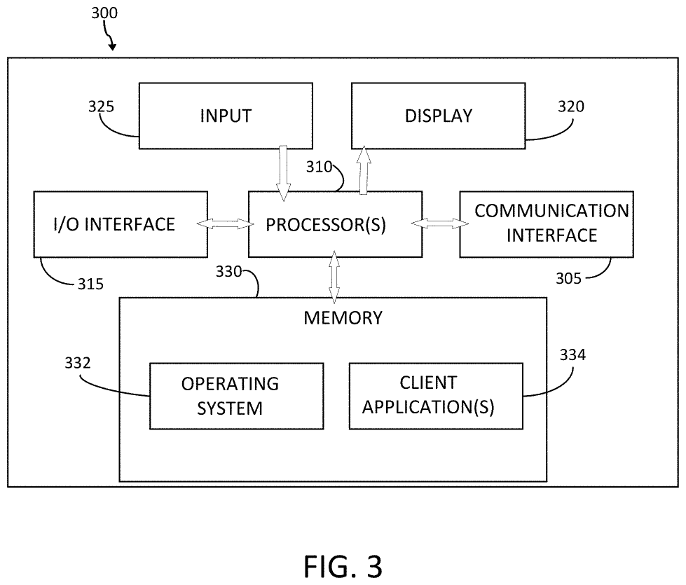

FIGS. 2 and 3 illustrate example computing devices in a networked system according to various embodiments of the present disclosure. In particular, FIG. 2 illustrates an example server 200, and FIG. 3 illustrates an example electronic device 300. In this illustrative example, the server 200 represents any one of the servers 102-103 in FIG. 1, and the electronic device 300 could represent one or more of the group electronic devices 106-108 in FIG. 1. The embodiment of the example server shown in FIG. 2 and the group electronic device 300 are for illustration only. Other embodiments of the server 200 and group electronic device 300 could be used without departing from the scope of this disclosure.

As shown in FIG. 2, the server 200 includes a bus system 205, which supports communication between processor(s) 210, storage devices 215, communication interface (or circuit) 220, and input/output (I/O) unit 225. The processor(s) 210 executes instructions that may be loaded into a memory 230. The processor(s) 210 may include any suitable number(s) and type(s) of processors or other devices in any suitable arrangement. Example types of processor(s) 210 include microprocessors, microcontrollers, digital signal processors, field programmable gate arrays, application specific integrated circuits, and discrete circuitry.

The memory 230 and a persistent storage 235 are examples of storage devices 215, which represent any structure(s) capable of storing and facilitating retrieval of information (such as data, program code, and/or other suitable information on a temporary or permanent basis). The memory 230 may represent a random access memory or any other suitable volatile or non-volatile storage device(s). The persistent storage 235 may contain one or more components or devices supporting longer-term storage of data, such as a read-only memory, hard drive, Flash memory, or optical disc. For example, persistent storage 235 may store one or more databases of data, standards data, results, data, client applications, etc.

The communication interface 220 supports communications with other systems or devices. For example, the communication interface 220 could include a network interface card or a wireless transceiver facilitating communications over the network 101. The communication interface 220 may support communications through any suitable physical or wireless communication link(s). The I/O unit 225 allows for input and output of data. For example, the I/O unit 225 may provide a connection for user input through a keyboard, mouse, keypad, touchscreen, or other suitable input devices. The I/O unit 225 may also send output to a display, printer, or other suitable output devices.

Although FIG. 2 illustrates one example of a server 200, various changes may be made to FIG. 2. For example, various components in FIG. 2 could be combined, further subdivided, or omitted and additional components could be added according to particular needs. As a particular example, while depicted as one system, the server 200 may include multiple server systems that may be remotely located. In another example, different server systems may provide some or all of the processing, storage, and/or communication resources for providing improvement recommendations in accordance with various embodiments of the present disclosure.

FIG. 3 illustrates an example group electronic device 300 according to embodiments of the present disclosure. The embodiment of the group electronic device 300 illustrated in FIG. 3 is for illustration only, and the group electronic devices 106-108 of FIG. 1 could have the same or similar configuration. However, group electronic devices come in a wide variety of configurations, and FIG. 3 does not limit the scope of this disclosure to any particular implementation of an electronic device. As shown in FIG. 3, the group electronic device 300 includes a communication interface (or circuit) 305, processor(s) 310, an input/output (I/O) interface 315, an input 325, a display 320, and a memory 330. The memory 330 includes an operating system (OS) 332 and one or more client applications 334.

The communication interface or circuit 305 supports communications with other systems or devices. For example, the communication interface 305 could include a network interface card or a wireless transceiver facilitating communications over the network 101. The communication interface 305 may support communications through any suitable physical or wireless communication link(s). For embodiments utilizing wireless communication, the communication interface 305 may receive an incoming RF signal via one or more antennas using a variety of wireless communication protocols, (e.g., Bluetooth, Wi-Fi, cellular, LTE communication protocols etc.).

The processor(s) 310 can include one or more processors or other processing devices and execute the OS 332 stored in the memory 330 in order to control the overall operation of the group electronic device 300. The processor(s) 310 is also capable of executing client application(s) 334 resident in the memory 330, such as, program code for one or more client applications for providing improvement recommendations. The processor(s) 310 can move data into or out of the memory 330 as required by an executing process. The processor(s) 310 is also coupled to the I/O interface 315, which provides the group electronic device 300 with the ability to connect to other devices, such as laptop computers and handheld computers. The I/O interface 315 provides a communication path between accessories and the processor(s) 310.

The processor(s) 310 is also coupled to the input 325 and the display 320. The operator of the group electronic device 300 can use the input 325 to enter data and inputs into the group electronic device 300. For example, the input 325 may be a touchscreen, button, keyboard, mouse, stylus, electronic pen, etc. The display 320 may be a liquid crystal display, light emitting diode display, or other display capable of rendering text and/or at least limited graphics, such as from websites. The memory 330 is coupled to the processor(s) 310. Part of the memory 330 could include a random access memory (RAM), and another part of the memory 330 could include a Flash memory or other read-only memory (ROM).

Although FIG. 3 illustrates one example of a group electronic device 300, various changes may be made to FIG. 3. For example, various components in FIG. 3 could be combined, further subdivided, or omitted and additional components could be added according to particular needs.

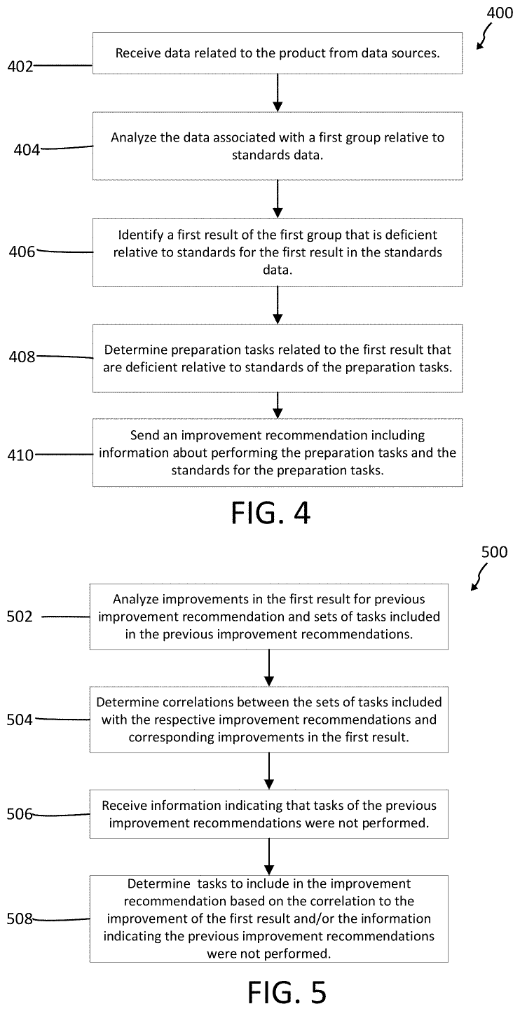

FIG. 4 illustrates a flowchart of a method 400 of providing improvement for the preparation of a product by a group according to various embodiments of the present disclosure. The group can be part of a plurality of groups, where the plurality of groups can be part of an enterprise. The method 400 can be performed by a server, such as the data server 102 previously described for providing improvement recommendations. The method 400 can be applied to any product prepared by a group of an enterprise of groups. For example, the method 400 can be applied to the production of industrial parts by a manufacturing site of an enterprise of manufacturing sites, the production of food products by a restaurant of an enterprise of restaurants, etc. For example, the method can be applied to the preparation of pizza by a franchise store (also referred to as a group) of a pizza chain enterprise. The franchise store can be one of a plurality of franchise stores within the pizza chain enterprise. Additionally, while examples for preparation of pizza are discussed below, any of these examples can be suitably applied to any other type of food or other product in any type of retail, manufacturing, and/or industrial environment. The flowchart of method 400 is for illustration only. Other embodiments of the method 400 could be used without departing from the scope of the disclosure.

In step 402, the server 102 can receive data related to the product from a plurality of different data sources. The data received by the sever can include different types of data. The data received by the server can include preparation data corresponding to each of the plurality of groups of the enterprise. Preparation data can be data associated with tasks performed by each of the plurality of groups in preparing the product. The preparation data can include any kind of score, percentage, attribute, feature, etc. used to describe the preparation of the product of by each of the plurality off groups. For example, the preparation data can include data related to how franchises, or groups, of a pizza chain enterprise prepare a pizza. The preparation data can include time used to prepare a pizza, oven temperature, pizza time in the oven, methods of preparing pizza for the oven, method of pizza delivery, cleanliness levels of oven, tools used in preparing the pizza, training of staff, or any other data associated with preparing a pizza. Further, the preparation data can be in the form of percentages or scores compared to a specific goal. For example, the preparation data for a time used to prepare the pizza can be a percentage based on a specific goal for the amount of time in which the preparation of pizza is desired (e.g., the preparation data can be that a group takes 10% longer than a set goal in an amount of time used to prepare the pizza).

The data received by the server 102 in step 402 can further include result data. The result data can be associated with results of the preparation of the product for each of the plurality of groups. Result data can include quality of the product, informalities of the product, or any other data associated with results of the product prepared by each of the groups of the enterprise. For example, for each of the plurality of groups of the pizza chain enterprise, the result data can include data related to the pizza created by each of the plurality of groups. The result data can include overall customer satisfaction, taste rating of pizza, appearance of pizza, temperature of pizza when delivered, size of pizza, promptness of service, cleanliness of restaurant, or any other data related to the pizza product prepared by the group. Further, the result data can be in the form of a percentage or score relative a goal of the of the result. For example, the result data can be that the pizza produced by a group 10% cooler in temperature than a desired temperature of the pizza.

The data received in by the server 102 in step 402 can also include standards data associated with standards of the enterprise. The standards data can include any standard an enterprise may put into place for its groups to adhere to in preparing the product. The standards can relate to results of the product made by the groups of the enterprise. For example, for a franchise, or group, of the pizza chain enterprise, the standards data can include a desired customer satisfaction score, dimensions of pizza, temperature of pizza when delivered, time to deliver pizza, or any other result of the pizza that a pizza enterprise may want to implement to ensure a certain quality or uniformity of pizza. The standards data can relate to standards regarding tasks for preparing the product. For example, the standards can relate to an amount of time used to cook a pizza, oven temperature when cooking a pizza, amount of toppings placed on the pizza during preparation, or any other task in creating the pizza that a pizza enterprise may want to implement to ensure a certain quality or uniformity of pizza. The standard information can also include information governed by a governmental body. For example, the standard information can include guidelines and rules established by the United States Food and Drug Administration.

In step 404, the server 102 can analyze the data received related to a first group of the plurality of groups of the enterprise relative to the standards data. For the first group, the server 102 can analyze the preparation data associated with tasks for the preparing the product relative to standards of the standards data associated with creating the pizza. For example, the server can analyze the amount of time a first group of the pizza chain enterprise leaves a pizza in the oven compared to a standard amount of time a pizza should be left in the oven set by the pizza enterprise. In step 404, any other preparation data related to tasks for preparing the product associated with the first group can be analyzed relative to corresponding standard data associated with the task for preparing the product.

In step 404, the server 102 can analyze, for the first group, result data associated with the results of preparation of the product relative to standards data associated with the result of the product. For example, the server can analyze a customer satisfaction score for pizza of the first enterprise relative to a standard customer satisfaction score that is desired for each of the plurality of groups. In step 404, any other result data associated with the results of the preparation of the product of the first group can be analyzed relative to corresponding standard data associated with the result of preparing the product.

In step 406, based on the analysis performed in step 404, the server 102 can identify a first result of the first group that is deficient relative to standards associated with the first result. The first result can be any result related to the product that is deficient relative to corresponding standards of the enterprise. For example, the first result can be related to a quality of the product, impurities of the product, customer rating of the product, or any other result that that can be deficient relative to a standard set by the enterprise. Specifically, the server can identify that the customer rating regarding the taste of the pizza prepared by the first group of the pizza enterprise is below the standard customer rating for taste established by the enterprise. For example, the enterprise may have a standard that each group of the enterprise receives a pizza taste average customer rating of 4 out of 5. The server 102, in step 406, can identify that the first group has a pizza taste average customer rating of 3.5 out of 5, which is deficient relative to the standard of 4 out of 5.

The server 102 can determine a score for the first result of the first group. For example, the first result can be that the pizza taste customer average is deficient for the first group compared to the enterprise standards, as described above. The server 102 can determine a score or percentage associated with deficient first result. For example, the server can assign a score of 3.5 out of 5 to the pizza taste average customer rating result of the first group. The server can also determine a score for the first result as a percentile or another numerical value.

In step 408, the server 102 can determine tasks performed by the first group that are related to the first result that are deficient relative to corresponding standards of the enterprise. Based on the identified first result, the server 102 can determine preparation tasks taken by the first group that are also deficient that are associated with the deficient first result. For example, as discussed above regarding step 406, the server can determine that the first group has a pizza taste average customer rating of 3.5 out of 5 (i.e., the first result). Based on this identified first result, the server 102 can identify the tasks taken by the first group in the preparation of the pizza that relate to the first result. The server 102 can determine preparation data associated with tasks for preparing the pizza that relate to the first result that are deficient relative to the standards data for the preparation of the pizza. For example, the server 102 can determine that, on average, the first group leaves the pizza in the oven 10 minutes longer than a standard amount of time the enterprise has set for the pizza to be left in the oven and that the prolonged oven exposure can lead to negative results in the taste of the pizza. As another example, the server 102 can determine that, on average, the first group takes 10 minutes longer to deliver pizza than a standard amount of time the enterprise has set for pizza delivery and that the prolonged pizza delivery can lead to negative results in the taste of the pizza.

In step 408, the server 102 can further determine a score related to the first groups performance of the tasks found to be deficient. For example, the score can be in the form of a percentage. For example, since it takes the first group 10 minutes longer than the standard to deliver a pizza, the server 102 can determine a score of the first group's performance of pizza delivery. The score can simply be a classifier such as “substandard” or “deficient.” The score can be a numerical score. The score can be a percentile score.

In step 410, the server 102, can send an improvement recommendation for improving the first result to a group electronic device 300 associated with the first group. The improvement recommendation can include information about performing the tasks associated the first result and standards information for the tasks. For example, the improvement recommendation can be related to improving a customer rating of the taste of pizza prepared by the first group. The improvement recommendation can include information that indicates that the first group has a customer rating for taste of 3.5 out of 5 and indicates that the desired customer rating for taste set by the enterprise is 4 out of 5. Further, the improvement recommendation can include information indicating how the creation tasks of the first group are deficient relative to the corresponding preparation tasks of the standards.

The improvement recommendation can include tasks completable by the first group that, when completed by the first group, are meant to improve the first result of the first group. For example, the improvement recommendations can include tasks for improving the taste of the pizza made by the first group that the first group can perform to improve the taste of the pizza.

The improvement recommendation can include information indicating the relationship between the score of the one or more deficient tasks relative to the related standards data. For example, the improvement recommendations can include information indicating how the pizza delivery speed of the first group is deficient relative to the corresponding standard.

The server 102 can further determine a predicted score related to the first result that is achievable by the first group based on the first group completing the improvement recommendation. For Example, as previously discussed, the server can determine a current score for the first result based on the customer ratings being a 3.5 out of 5 for taste of the pizza. The server 102 can predict an achievable score of the first result that the first group can achieve based on following the tasks of the improvement recommendation. For example, the server can determine that a predicted score for the taste of the pizza of the first group can raise from a 3.5 to a 4.1 based on the first group following the tasks of the improvement recommendation.

In step 410, the server 102 can send a plurality of improvement recommendations to the electronic device of the first group, each of the plurality of improvement recommendations including tasks for improving a respective result of the first group. For each of the plurality of improvement recommendations, the server 102 can determine how much the improvement recommendation can improve the respective result.

For example, as previously discussed, the server 102 can determine a first improvement recommendation related to a fist result related to the taste of the pizza. Additionally, the server can determine a second improvement recommendation related to a second deficient result of the first group. For example, the second improvement recommendation can be related to improving a deficient delivery time of the pizza of the first group.

The server 102 can further determine a ranking of the plurality of improvement recommendations based on a degree that completion of the improvement recommendations by the first group will improve the associated result.

For example, the server 102 can determine that the completion of the first improvement recommendation by the first group will improve the pizza taste customer average by 20% if the first group completes the first improvement recommendation. The server 102 can determine that the completion of the second improvement recommendation by the first group will improve the pizza delivery time by 10%. Accordingly, the server 102 can determine that the completion of the first improvement recommendation will result in a greater degree of improvement to the taste of the pizza than the completion of the second improvement recommendation will have on the delivery time of the pizza and can rank the first improvement recommendation as more important than, or above, the second improvement recommendation for the first group to perform.

The server 102 may perform the ranking for a plurality of improvement recommendations corresponding to a plurality of results. Additionally, the server 102 can rank multiple improvement recommendation related to a same result. For example, the server 102 can determine multiple improvement recommendations related to improving the taste of the pizza of the first group. The server 102 can rank the multiple improvement recommendations related to improving the taste according to the degree by which completion of each of the multiple improvement recommendations will improve the taste of the pizza.

The server 102 can send the plurality of improvement recommendations including the ranking information to the electronic device associated with the first group. For example, the server 102 can send the top five improvement recommendations based on the ranked order of the improvement recommendations.

The server 102 can further determine a score for each of the plurality of groups based on the result data associated with each of the plurality of groups. The server 102 can rank the plurality of groups according to the determined score of each of the plurality of groups. For example, based on the results data of the pizza of the first group, the server 102 can assign an overall score to a group based on the totality of the different results associated with that group. For example, the server 102 can determine a score of 4.6 out of 5 for the first group, 4.2 out of 5 for the second group, and 3.8 out of 5 for a third group. The server can then rank the groups according to the determined score. Accordingly, the server can rank the first group as the best performing group, the second group and the second best performing group, and the third group as the third best performing group.

FIG. 5 illustrates a flowchart of a machine learning process 500 for determining tasks to include in an improvement recommendation according to various embodiments of the present disclosure. The machine learning process 500 can be performed by the data server 102 for determining tasks to include in improvement recommendations. The machine learning process can be a process of analyzing sample training data to build mathematical models. Further, the machine learning process can iteratively optimize the models based on new data being introduced to the server 102. Accordingly, the machine learning process 500 can iteratively performed by server 102. The flowchart of the machine learning process 500 is for illustration only. Other embodiments of the machine learning process 500 could be used without departing from the scope of the disclosure.

As discussed above, the server 102 can send improvement recommendations to groups of an enterprise to improve deficient result related to each of the groups. For illustration purposes, a server 102 has been described as sending improvement recommendations to a first group of a pizza enterprise to improve the taste of the pizza prepared by the first group. In doing this, the server 102 identifies preparation tasks performed by the first group that are deficient compared to standards of the enterprise and includes those tasks in the improvement recommendation sent to the first group.

The server 102 can identify the tasks to include in the improvement recommendation of the first group based on improvement recommendations for improving the first result already sent to other groups of the enterprise. For example, previously, the server 102 may have identified that groups A-J of the enterprise all had taste results for their pizza that were deficient relative to the standards of the enterprise. Based on the deficient results, the server may have identified that groups A-E had deficient preparation data related to the preparation task of the amount of time the pizza is in the oven (“oven time”). Accordingly, the server 102 may have sent improvement recommendations to groups A-E for improving the result of the taste of the pizza with information for improving the task of the oven time.

Based on the deficient results, the server may have identified that groups F-J had deficient preparation data related to the preparation task of the applying the pizza toppings in a consistent order (“pizza topping order”). Accordingly, the server 102 may have sent improvement recommendations to groups F-J for improving the result of the taste of the pizza with information for improving the tasks of pizza topping order.

As previously discussed, the improvement recommendations sent to groups A-J can be sent as part of collecting training data for the machine data process or can be sent to collect data than can be iteratively used to improve the machine learning process.

In step 502, the server 102 can analyze the improvement recommendations sent to the groups of the enterprises and the associated tasks included in the improvement recommendations.

In step 504, the server 102 can identify whether the first results of the groups improve by completing the improvement recommendations. For example, the server 102 can identify if the pizza taste result for groups A-J improved, declined, or remained the same after completing the improvement recommendation.

In step 504 the server can determine correlations between tasks included in improvement recommendations and corresponding improvements of the first result. The server may identify that tasks correlate to the improvement of the first result, tasks correlate to a decline in the first result, or that tasks do not affect the first result. The server 102 can determine that the result of pizza taste improved for groups A-E after performing the improvement recommendation including information for improving the task of the oven time. The server 102 can determine that the result of pizza taste remained the same for groups F-J after performing the improvement recommendation including information for improving the pizza topping order.

Accordingly, the server 102 can determine that tasks related to improving oven time correlate to an improvement in the result of taste of the pizza and that tasks related to pizza topping order do not have an effect on the result of the taste of the pizza.

Based on the correlations determined in step 504, in step 508, the server 102 can determine the task information to include in the improvement recommendation made to the first group. The server 102 can determine that the improvement recommendation for improving the result of taste of the pizza sent to the first group should include information related to the task of improving oven time since this information correlated to improved pizza taste for groups A-E. The server 102 can determine to not include the information related to the tasks of pizza topping order since this information did not correlate to an improve result of pizza taste for groups F-J.

Further, in step 506, the server can receive information indicating that tasks of a previous improvement recommendations were not performed by the groups the respective improvement recommendations were sent to. For example, the server 102 may have sent improvement recommendations related to improving the result pizza taste including tasks information related to setting tables to groups A-J. The server 102 may receive feedback from groups A-I that the improvement recommendation was not performed by the group. The feedback from groups A-I may include information indicating that the improvement recommendation was not related to improving the taste of the pizza.

With the information received in step 506, the server 102 can determine whether to include the task information in the improvement recommendation in step 510. For example, since the majority of groups (groups A-I) indicated that the improvement recommendation including information related to the task of setting the table was not performed, the server 102 may not include tasks information related to the setting tables in the improvement recommendation for improving taste.

Although FIGS. 4 and 5 illustrate examples of processes implemented in accordance with various embodiments of the present disclosure, various changes could be made to FIGS. 4 and 5. For example, while shown as a series of steps, various steps in each figure could overlap, occur in parallel, occur in a different order, or occur multiple times. In another example, steps may be omitted or replaced by other steps.

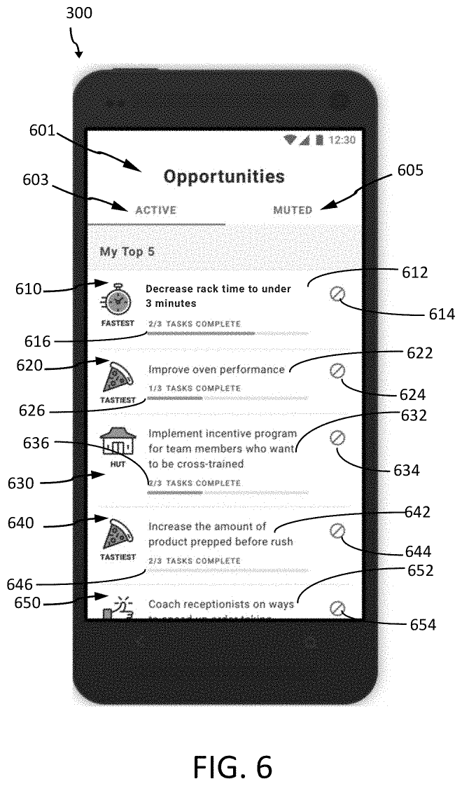

FIG. 6 illustrates the group electronic device 300 associated a group. In FIG. 6, the group electronic device group 300 is a smartphone device, although, as previously discussed, the electronic device can be a number of different electronic devices. The group electronic device 300 is illustrated as displaying an opportunities screen 601 according to an embodiment of this disclosure. The opportunities screen 601 is for illustration only. Other embodiments of the opportunities screen 601 could be used without departing from the scope of the disclosure.

The opportunities screen 601 can be used by the group to view improvement recommendations 610, 620, 630, 640, and 650 for improving its product. While five improvements recommendations 610, 620, 630, 640, and 650 are displayed in FIG. 6, one skilled in the art will understand that any number of improvements recommendations can be displayed on the opportunities screen 601.

The improvement recommendations can be displayed in an active section 603 of the opportunities screen or a muted section 605 of the opportunities screen. Within the opportunities screen 601, the user may toggle back and forth between the active section 603 and the muted section 605. The active section 603 and the muted section 605 can be selectable by the group so that the user can toggle back and forth between the sections. For example, the user can touch the “ACTIVE” text of the active section 603 to view the improvement recommendations in the active section and may touch the “MUTED” text of the muted section 605 to view the improvement opportunities of the muted section. FIG. 1 illustrates improvement recommendations 610, 620, 630, 640, and 650 of the active section 603.

Improvement recommendations 610, 620, 630, 640, and 650 can be automatically populated to the active section 603. However, a user can move an improvement recommendation 610, 620, 630, 640, and 650 from the active section 603 to the muted section 605. The user can move an improvement recommendation 610, 620, 630, 640, and 650 from the active section 603 to the muted section 605 by selecting the corresponding muting character 614, 624, 634, 644, 654. A group may move an improvement recommendation to the muted section if they believe that the improvement recommendation does not apply to their product or will not help them to improve the results of their product. For example, if a group does not think the improvement recommendations 620 of improving oven performance will improve the pizza produced by the owner, the owner can touch muting character 624. When the owner selects the muting character 624, the improvement recommendation 620 is removed from the active section 603 and moved to the muted section 105.

As previously discussed, each improvement recommendation can be directed to a different aspect of the result of food product. Each improvement recommendation 610, 620, 630, 640, and 650 may include a respective description section 612, 622, 632, 642, and 652 in which the improvement recommendation is described. For example, as illustrated in FIG. 6, improvement recommendations 620 and 640 are related to the taste of the food. As illustrated in FIG. 6, improvement recommendation 610 is related to decreasing the rack time. As illustrated in FIG. 6, improvement recommendation 630 is related to cross-training restaurant staff. However, one skilled in the art will recognize that improvement recommendations can be directed to any of a number of results a food product and aspects of operating a restaurant and is not limited to those illustrated in improvement recommendations 610, 620, 630, 640, and 650.

As previously discussed, each of the improvement recommendations 610, 620, 630, 640, and 650 can include a number of improvement tasks related to the respective improvement recommendation. Each of the improvement recommendations includes a task status indicator 616, 626, 636, 646, and 656 displayed on the active section 603 with the respective improvement recommendation 610, 620, 630, 640, and 650 indicating how many of the tasks for the respective task recommendation have been complete. For example, referring to FIG. 6, task status indicator 616 indicates that two of three tasks have been completed by the group for the improvement recommendation 610.

Each of the improvement recommendations 610, 620, 630, 640, and 650 can be selectable by the group. A user of the group can touch each improvement recommendations 610, 620, 630, 640, and 650 to select the improvement recommendation. When an improvement recommendation 610, 620, 630, 640, and 650 is selected, an improvement recommendation details screen including details associated with the selected recommendation can be displayed. The improvement recommendation details screen can include a tasks section including improvement tasks of the respective improvement recommendation.

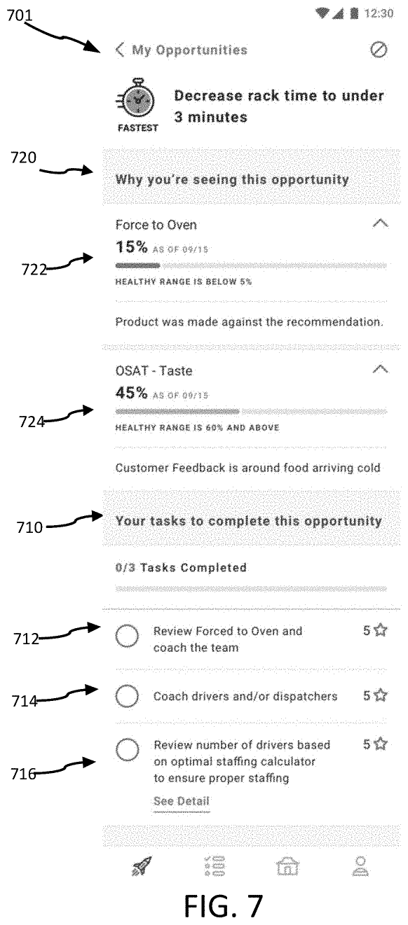

FIG. 7 illustrates an example of an improvement recommendation details screen 701 according to various embodiments of the present disclosure. The improvement recommendation details screen 701 may be displayed in response to one of the improvement recommendations being selected by the group. The recommendation detail screen may include information related to tasks for accomplishing the improvement recommendation and data that explains to the group why the group is being provided with the improvement recommendation. For example, if improvement recommendation 610 is selected by the group, the improvement recommendation details screen 701 may be displayed to the group. The improvement recommendation details screen 701 may include an improvement tasks section 710 illustrating the task information related to the improvement recommendation. The tasks information can be completed by the group in order to accomplish the selected improvement recommendation. FIG. 7 illustrates that the improvement tasks section can include tasks 712, 714, and 716. For example, to accomplish the improvement recommendation 610 of decreasing the rack time to under three minutes, the user can complete task 712 of reviewing forced to oven and coaching the team, task 714 of coaching drivers and/or dispatchers, and task 716 of reviewing the number of drivers based on optimal staffing calculator to ensure proper staffing. Once a user has completed all of the improvement tasks of the improvement recommendation 610, improvement recommendation 610 can be removed from the active section 603 of the opportunities screen 601. The group may indicate that tasks 712, 714, and 716 have been completed by selecting the tasks.

When an improvement recommendation 610, 620, 630, 640, and 650 is selected by the group, the displayed improvement recommendation details screen 701 may include an explanation section that includes data that explains to the group why the group is being provided with the improvement recommendation 610, 620, 630, 640, and 650. For example, when a group selects improvement recommendation 610 of FIG. 6, the improvement recommendation details screen 701 can include explanation section 720.

FIG. 7 illustrates an example of an explanation section 720 of an electronic device 300 according to various embodiments of the present disclosure. The explanation section 720 compares data related to preparation tasks performed by the group in preparing the product (preparation data of the group) with standards of standard information established by the enterprise. The explanation screen includes results of the comparison made 722, 724 explaining why the user is being provided with improvement recommendation 610. Here, as illustrated in FIG. 6, the improvement recommendation 610 is related to decreasing a rack time. Explanation section 720 explains with comparison 722 that the user's force to oven data is at 15% (preparation data of the group), when a desired range is below 5% (standard information). Further, explanation section 720 explains with comparison 724 that a taste score of the pizza cooked by the user is 45% (preparation data of the user), when a desired range is 60% and above (standard information). The improvement recommendation details screen 701 and the improvement task section 710 and explanation section 720 included therein is for illustration only. Other embodiments of the improvement recommendation details screen 701 could be used without departing from the scope of the disclosure.

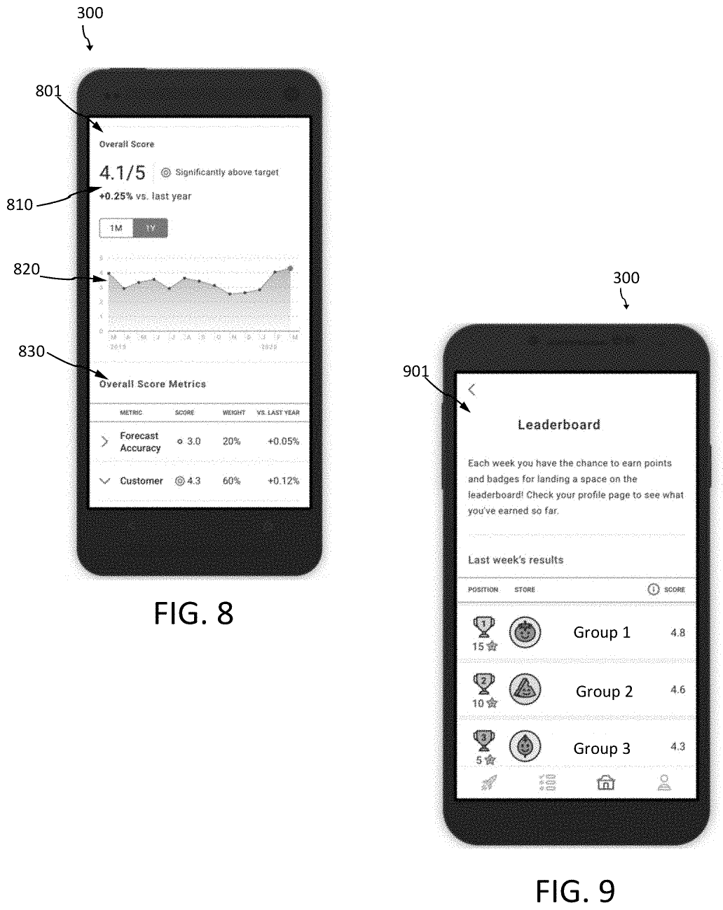

FIG. 8 illustrates an example of a score review screen 801 of an electronic device 300 according to various embodiments of the present disclosure. The score review screen 801 can display a score determined by server 102 associated with a group on the group electronic device 300. The score review screen 801 is for illustration only. Other embodiments of the score review screen 801 could be used without departing from the scope of the disclosure.

As previously discussed, server 102 can determine a score associated each of the groups of the plurality of groups of the enterprise. FIG. 9 illustrates a score review screen 801 displaying the score determined by the server 102 for a group. The score includes an overall score 810 of the group. The score can also include a score tracker 820 illustrating a tracking of the overall score 810 of the group over a period of time.

The score can also include score metrics 830 providing details on the basis of the determined overall score 810.

As previously described, the server 102 can also rank the plurality of groups of an enterprise according to the respective overall score of each of the plurality of groups.

FIG. 9 illustrates an example of a leader board screen 901 of an electronic device 300 according to various embodiments of the present disclosure. The leader board screen 901 may display the plurality of groups provided in a ranked order based on the overall score of each group determined by the server 102. The leader board screen 901 is for illustration only. Other embodiments of the leader board screen 901 could be used without departing from the scope of the disclosure.

Referring to FIG. 9, the leader board screen 901 displays that a Group 1 has a highest score of the plurality of groups with a score of 4.8. The leader board screen 1001 displays that a Group 2 has a second highest score of the plurality of groups with a score of 4.6. The leader board screen 901 displays that a Group 3 has a third highest score of the plurality of groups with a score of 4.3.

It may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “such as,” when used among terms, means that the latter recited term(s) is(are) example(s) and not limitation(s) of the earlier recited term. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described herein can be implemented or supported by one or more computer programs, each of which is formed from computer readable program code and embodied in a computer-readable medium. The terms “application” and “program” refer to one or more computer programs, software components, sets of instructions, procedures, functions, objects, classes, instances, related data, or a portion thereof adapted for implementation in a suitable computer readable program code. The phrase “computer-readable program code” includes any type of computer code, including source code, object code, and executable code. The phrase “computer-readable medium” includes any type of medium capable of being accessed by a computer, such as read-only memory (ROM), random access memory (RAM), a hard disk drive, a compact disc (CD), a digital video disc (DVD), or any other type of memory. A “non-transitory” computer-readable medium excludes wired, wireless, optical, or other communication links that transport transitory electrical or other signals. A non-transitory, computer-readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases. Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of the patented subject matter is defined by the claims.

What is claimed is:

1. A method for providing improvement recommendations for preparing a product, the method comprising:
receiving data related to the product from data sources, the data including:
preparation data associated with tasks for preparing the product for each of a plurality of groups creating the product, the plurality of groups being within an enterprise,
result data associated with results for preparation of the product for each of the plurality of groups, and
standards data associated with standards for the enterprise for the results for preparation of the product and for the tasks for preparing the product;
analyzing, for a first of the plurality of groups, the preparation data associated with the tasks and the result data associated with the results for preparation of the product relative to the standards data for the results for preparation of the product and for the tasks for preparing the product in the standards data;
identifying, based on results of the analyzing, a first of the results of the first group that is deficient relative to the standards for the first result in the standards data;
determining one or more of the tasks that are associated with the first result and that are deficient relative to the standards for the one or more tasks for preparing the product in the standards data; and
sending, to an electronic device associated with the first group, at least one improvement recommendation including information about performing the one or more tasks and the standards for the one or more tasks.

2. The method of claim 1, wherein:
the at least one improvement recommendation comprises a plurality of improvement recommendations, and
the method further comprises:
determining a ranking for each of the plurality of improvement recommendations based on degree that completion of the respective improvement recommendation is predicted to improve the respective result, and
sending, to the electronic device associated with the first group, a predetermined number of the plurality of improvement recommendations and information indicating the ranking among the predetermined number of improvement recommendations based on the determined ranking.

3. The method of claim 1, wherein:
the determining of the one or more of the tasks that are associated with the first result that are deficient further comprises determining a score related to the preparation of the product based on the one or more tasks determined to be deficient, and
the at least one improvement recommendation further includes information indicating a relationship between the score related to the preparation of the product based on the one or more tasks and a score of corresponding standards of the standards data.

4. The method of claim 1, wherein:
the first result includes a current score related to the preparation of the product,
the method further includes determining, for first group, an achievable predicted score for the first result after completion of the at least one improvement recommendation by the first group, and
the at least one improvement recommendation further includes information indicating the achievable predicted score.

5. The method of claim 1, further comprising:
determining an overall score for each of the plurality of groups that is a function of the result data associated with each of the plurality of groups; and
determining a ranking of the plurality go groups based in the determined overall score for each of the plurality of groups.

6. The method of claim 1, wherein:
determining the one or more of the tasks comprises using a machine learning process including:
analyzing improvements in the first result for previous improvement recommendations for groups in the plurality of groups and sets of tasks included in respective ones of the previous improvement recommendations;
determining correlations between the sets of tasks included in the respective previous improvement recommendations and corresponding improvements in the first result; and
determining the one or more tasks to include in the at least one improvement recommendation based on the correlations to the improvements in the first result.

7. The method of claim 6, wherein:
receiving the data further comprises receiving information indicating tasks included in the previous improvement recommendations that were selected not to be performed, and
using the machine learning process in determining the one or more of the tasks further comprises determining the one or more tasks to include in the at least one improvement recommendation further based on the tasks included in the previous improvement recommendations that were selected not to be performed.

8. A server configured to provide improvement recommendations for preparing a product, the server comprising:
a communication interface configured to receive data related to the product from data sources, the data including:
preparation data associated with tasks for preparing the product for each of a plurality of groups creating the product, the plurality of groups being within an enterprise,
result data associated with results for preparation of the product for each of the plurality of groups, and
standards data associated with standards for the enterprise for the results for preparation of the product and for the tasks for preparing the product; and
a processor operably connected to the communication interface, the processor configured to:
analyze, for a first of the plurality of groups, the preparation data associated with the tasks and the result data associated with the results for preparation of the product relative to the standards data for the results for preparation of the product and for the tasks for preparing the product in the standards data;
identify, based on results of the analyzing, a first of the results of the first group that is deficient relative to the standards for the first result in the standards data;
determine one or more of the tasks that are associated with the first result and that are deficient relative to the standards for the one or more tasks for preparing the product in the standards data; and
send, via the communication interface to an electronic device associated with the first group, at least one improvement recommendation including information about performing the one or more tasks and the standards for the one or more tasks.

9. The server of claim 8, wherein:
the at least one improvement recommendation comprises a plurality of improvement recommendations, and
the processor is further configured to:
determine a ranking for each of the plurality of improvement recommendations based on degree that completion of the respective improvement recommendation is predicted to improve the respective result, and
send, via the communication interface to the electronic device associated with the first group, a predetermined number of the plurality of improvement recommendations and information indicating the ranking among the predetermined number of improvement recommendations based on the determined ranking.

10. The server of claim 8, wherein:
to determine the one or more of the tasks that are associated with the first result that are deficient, the processor is further configured to determine a score related to the preparation of the product based on the one or more tasks determined to be deficient, and
the at least one improvement recommendation further includes information indicating a relationship between the score related to the preparation of the product based on the one or more tasks and a score of corresponding standards of the standards data.

11. The server of claim 8, wherein:
the first result includes a current score related to the preparation of the product,
the processor is further configured to determine, for first group, an achievable predicted score for the first result after completion of the at least one improvement recommendation by the first group, and
the at least one improvement recommendation further includes information indicating the achievable predicted score.

12. The server of claim 8, wherein the processor is further configured to:
determine an overall score for each of the plurality of groups that is a function of the result data associated with each of the plurality of groups; and
determine a ranking of the plurality go groups based in the determined overall score for each of the plurality of groups.

13. The server of claim 8, wherein, in determining the one or more of the tasks, the processor is further configured to perform a machine learning process in which the processor is further configured to:
analyze improvements in the first result for previous improvement recommendations for groups in the plurality of groups and sets of tasks included in respective ones of the previous improvement recommendations;
determine correlations between the sets of tasks included in the respective previous improvement recommendations and corresponding improvements in the first result; and
determine the one or more tasks to include in the at least one improvement recommendation based on the correlations to the improvements in the first result.

14. The server of claim 13, wherein:
the communication interface is further configured to receive information indicating tasks included in the previous improvement recommendations that were selected not to be performed, and
to use the machine learning process to determine the one or more of the tasks, the processor is further configured to determine the one or more tasks to include in the at least one improvement recommendation further based on the tasks included in the previous improvement recommendations that were selected not to be performed.

15. A non-transitory, computer-readable medium comprising program code that, when executed by a processor of a server, causes the server to:
receive data related to the product from data sources, the data including:
preparation data associated with tasks for preparing the product for each of a plurality of groups creating the product, the plurality of groups being within an enterprise,
result data associated with results for preparation of the product for each of the plurality of groups, and
standards data associated with standards for the enterprise for the results for preparation of the product and for the tasks for preparing the product;
analyze, for a first of the plurality of groups, the preparation data associated with the tasks and the result data associated with the results for preparation of the product relative to the standards data for the results for preparation of the product and for the tasks for preparing the product in the standards data;
identify, based on results of the analyzing, a first of the results of the first group that is deficient relative to the standards for the first result in the standards data;
determine one or more of the tasks that are associated with the first result and that are deficient relative to the standards for the one or more tasks for preparing the product in the standards data; and
send, to an electronic device associated with the first group, at least one improvement recommendation including information about performing the one or more tasks and the standards for the one or more tasks.

16. The computer-readable medium of claim 15, wherein:
the at least one improvement recommendation comprises a plurality of improvement recommendations, and
the computer-readable medium further comprises program code that, when executed by the processor, causes the server to:
determine a ranking for each of the plurality of improvement recommendations based on degree that completion of the respective improvement recommendation is predicted to improve the respective result, and
send, to the electronic device associated with the first group, a predetermined number of the plurality of improvement recommendations and information indicating the ranking among the predetermined number of improvement recommendations based on the determined ranking.

17. The computer-readable medium of claim 15, wherein:
for the determining of the one or more of the tasks that are associated with the first result that are deficient, the computer-readable medium further comprises program code that, when executed by the processor, causes the server to determine a score related to the preparation of the product based on the one or more tasks determined to be deficient, and
the at least one improvement recommendation further includes information indicating a relationship between the score related to the preparation of the product based on the one or more tasks and a score of corresponding standards of the standards data.

18. The computer-readable medium of claim 15, wherein:
the first result includes a current score related to the preparation of the product,
the computer-readable medium further comprises program code that, when executed by the processor, causes the server to determine, for first group, an achievable predicted score for the first result after completion of the at least one improvement recommendation by the first group, and
the at least one improvement recommendation further includes information indicating the achievable predicted score.

19. The computer-readable medium of claim 15, further comprising program code that, when executed by the processor, causes the server to:
determine an overall score for each of the plurality of groups that is a function of the result data associated with each of the plurality of groups; and
determine a ranking of the plurality go groups based in the determined overall score for each of the plurality of groups.

20. The computer-readable medium of claim 15, wherein, for determining the one or more of the tasks the computer-readable medium further comprises program code that, when executed by the processor, causes the server to perform a machine learning process in which the server is further configured to:
analyze improvements in the first result for previous improvement recommendations for groups in the plurality of groups and sets of tasks included in respective ones of the previous improvement recommendations;
determine correlations between the sets of tasks included in the respective previous improvement recommendations and corresponding improvements in the first result; and
determine the one or more tasks to include in the at least one improvement recommendation based on the correlations to the improvements in the first result.
